(19) United States
(12) Patent Application Publication
(10) Pub. No.: US 2024/0161982 A1
(43) Pub. Date: May 16, 2024

(54) Capacitor System with Improved Connections, and Production Method

(71) Applicant: Bayerische Motoren Werke Aktiengesellschaft, Muenchen (DE)

(72) Inventors: Stefan EHRENREICH, Neusaess (DE); Erick Maximiliano HAAS RUGEL, Muenchen (DE); Christoph HAHN, Bad Feilnbach (DE); Roman HAMERSKI, Unterhaching (DE); Maximilian HERRNBERGER, Oberhaching (DE)

(21) Appl. No.: 18/281,797

(22) PCT Filed: Feb. 22, 2022
(86) PCT No.: PCT/EP2022/054407

§ 371 Date: Sep. 13, 2023

(30) Foreign Application Priority Data
Mar. 16, 2021 (DE) 10 2021 106 414.7

(51) Int. Cl. H01G 4/38; H01G 5/38; H01G 9/26; H01G 11/10; H01G 15/00

(52) U.S. Cl. CPC H01G 4/38; H01G 5/38; H01G 9/26; H01G 11/10; H01G 15/00

(57) ABSTRACT

A capacitor system is disclosed that includes a first capacitor with a connection for a first pole and a connection for a second pole and a second capacitor with a connection for a first pole and a connection for a second pole. The first poles are like poles in relation to one another and the second poles are like poles in relation to one another and the first poles are of a polarity different from the second poles. Two different-polarity connections of two capacitors are connected to the capacitors on one side of the capacitor system and lead out from the capacitor system at a substantially constant distance from one another, in parallel and/or in a twisted state.

### BACKGROUND AND SUMMARY OF THE INVENTION

The present disclosure relates to capacitor systems with a plurality of capacitors, wherein electrical interferences are minimized by an arrangement of the electrical outputs of the capacitor systems. Also disclosed are methods for producing these capacitor systems.

Capacitor systems with a plurality of capacitors are usually wired in parallel so that there is the same voltage available at each capacitor and the overall capacity is increased. The connectors of the capacitor system have to be electrically coupled to at least one positive connector of a capacitor of the capacitor system as well as to a negative connector of a capacitor of the capacitor system. It may also occur that the capacitor system has a plurality of positive connectors and a plurality of negative connectors. This is required in particular when the capacitor system is to connect a plurality of electrical sub-systems to one another, for example, in an intermediate circuit. In order to be able to connect the capacitor to an electric circuit, the connectors have to lead out of the capacitor system in a correspondingly structured manner. This typically takes place by busbars which by corresponding bends are guided within the capacitor system so that these busbars open into stable connectors at a defined position of the capacitor system. The bent busbars disadvantageously lead to induction effects and a not insignificant requirement in terms of material. Improvements in these fields are desirable.

It is an object of the present invention to specify an improved capacitor system.

This object is achieved by the technology disclosed which is defined by the subject matter of the independent claims. The dependent claims relate to corresponding refinements. Various aspects and embodiments of these aspects, which provide additional features and advantages, will be disposed hereunder.

Some exemplary embodiments achieve the special object of minimizing induction losses in a capacitor system. In this respect, a plurality of capacitors with alternating polarity directions are disposed on a busbar. Moreover, the capacitors are disposed in an offset manner. As a result of the alternating polarization, a positive output of a first capacitor and a negative output of a further capacitor can lead out of the capacitor system close to one another. As a result of the offset disposal of both capacitors, the outputs can moreover lead out of the capacitor system in a rectilinear manner, thus with ideally few changes in direction. As a result, electrical interferences, for example, induction losses, which are facilitated by changes in direction of the connectors, can be minimized. Furthermore, the amount of material, e.g., copper, required for the connectors is minimized as a result of the rectilinear routing of the connectors.

Further aspects in this respect and embodiments of these aspects will be disclosed hereunder.

A first aspect relates to a capacitor system comprising:
a first capacitor with a first connector for a first pole and a connector for a second pole;
a second capacitor with a connector for a first pole and a connector for a second pole, wherein the first poles are identically denominated poles and the second poles are identically denominated poles, and the first poles and the second poles are non-homopolar; and
wherein two non-homopolar connectors of two capacitors:
are connected to the capacitors on one side of the capacitor system;
and
lead out of the capacitor system at a substantially consistent mutual spacing, in particular in parallel and/or twisted.

In principle, different types of capacitors can be used as capacitors of the capacitor system. Capacitors with a fixed capacity as well as capacitors with a variable capacity, or a combination of both types of capacitors, can be considered as capacitors. A capacitor can be a film capacitor, for example, a paper film capacitor and/or a plastic film capacitor. Alternatively, or in combination, a capacitor can be a ceramic capacitor, for example, an MDK ceramic capacitor or an HDK capacitor. A capacitor can likewise be a mica capacitor. For example, a capacitor system can comprise an electrolytic aluminum capacitor and/or an electrolytic tantalum capacitor and/or a double layer capacitor. As a capacitor with variable capacity which can likewise be used as a type of capacitor, a rotary capacitor, or a trim capacitor, can be considered.

A capacitor system can comprise one or a plurality of the above-mentioned capacitor types, in particular different capacitor types, as capacitors. A capacitor system can comprise a plurality of capacitors which are disposed at different locations in the capacitor system. In particular, a capacitor system can comprise a layered capacitor or a plurality of layered capacitors.

A film capacitor (also: film/foil capacitor, wound capacitor) is, for example, a capacitor which comprises at least one wrapping. A wrapping is an element in which a plurality of layers, typically films, are wound up. A connector of a capacitor is an element by way of which a voltage provided by the capacitors of the capacitor system can be tapped. The means that a film capacitor can be charged and/or discharged by way of the connectors. Each film capacitor typically has a first and a second connector of different polarities. A connector can be coupled to a wrapping by way of a schoopage.

The capacitor system can be composed of different capacitors or identical capacitors. A capacitor system can be composed of identical types of capacitors, which however have different dimensions and/or are disposed so as to be mutually rotated.

Capacitors of the capacitor system can be wired in parallel. A pole of a capacitor system, or of a capacitor, respectively, can either be a positive pole or a negative pole.

The capacitor system can be configured as an intermediate circuit capacitor. As an intermediate circuit capacitor, the capacitor system can couple a power supply side to a power consumer side. In an electric locomotive, for example, electric power from the railroad AC voltage supply network can be fed into an intermediate circuit via an H-bridge. The network AC voltage is converted into a DC voltage (the intermediate circuit voltage) in the process. In the driving mode, this power can in turn by converted into an AC voltage of variable frequency for the electric motors via a pulse inverter. In another example, electric power can be transported via an intermediate circuit from a DC battery to a frequency inverter which provides AC power for an electric drive motor of a vehicle.

A substantially consistent mutual spacing of two non-homopolar connectors is understood to mean that the connectors within the scope of technical/physical variances have a consistent spacing. In a comparatively large capacitor system, a substantially consistent spacing may include greater variances than in a comparatively small capacitor system. Alternatively, the term “substantially” is understood to mean a standard error of a corresponding mean value as caused by the production method. Alternatively, the term “substantially” is understood to mean that deviations from a mean value may occur to the extent that the advantages of the respective embodiment can still be achieved in the process.

A substantially consistent spacing can be achieved in that the connectors are led next to one another. This can take place with connectors which are implemented by rails, e.g., copper rails. The connectors can be led in parallel when next to one another.

Additionally or alternatively, a consistent spacing can be implemented in that the connectors are twisted about one another. Twisting describes intertwining and/or helical wrapping about one another. This can take place in particular with wire-type connectors. However, rail-type connectors may also be of a twisted embodiment.

It can advantageously be achieved by this type of connectors that inductive interferences are minimized. Additionally, savings in terms of material can advantageously be achieved.

One embodiment of the first aspect relates to a capacitor system wherein the connectors are led at a substantially consistent spacing at least over one portion of a capacitor or completely over one capacitor.

Depending on the orientation of the capacitor, the term “over” may also mean “below” or “laterally next to”. In particular, a connector of a capacitor can lead over an adjacent capacitor of the capacitor system and thereby run parallel to the anti-pole connector of this capacitor. In another embodiment, the connector of the first capacitor, as soon as it leads over the second capacitor, can be twisted with the connector of the second capacitor.

One embodiment of the first aspect relates to a capacitor system wherein the connectors have a smooth profile in that region in which the connectors are led at the same spacing.

The term “smooth” is understood to mean that there are no kinks in the profile of the connectors in at least one portion of the latter. The term “smooth” herein may in particular be understood as “mathematically smooth”, i.e., that the profile of the connectors can be infinitely differentiated without a differentiation displaying any discontinuity.

One embodiment of the first aspect relates to a capacitor system wherein the capacitors are disposed so as to be laterally offset from one another.

The capacitors can be laterally offset such that as a result non-homopolar connectors of two capacitors are led next to one another if these capacitors are disposed next to one another. In particular, two capacitors of one type can be disposed next to one another, wherein the capacitors are installed so as to be mutually rotated by 180°. In this instance, two non-homopolar connectors are at the same level if the capacitors are disposed without an offset. As a result of an offset, the connectors lead out of the capacitor system next to one another at a substantially identical spacing.

One embodiment of the first aspect relates to a capacitor system wherein the consistent spacing of two non-homopolar connectors is defined by the offset of the capacitors, according to at least one of the following parameters:
a thickness of the connectors and/or a thickness of an insulating layer;
an external electrical functional group to be connected.

As a result thereof, the lateral offset of two capacitors of the capacitor system disposed next to one another is defined by a necessary, substantially identical spacing of the two non-homopolar connectors. This is because the two connectors cannot lead closer to one another than is made possible by the thickness of the connectors and/or the thickness of an insulating layer that lies between the connectors. The offset is, for example, the width resulting from the width of the connectors and the width of the insulating layer.

In the second alternative set forth above, the lateral offset of two capacitors lying next to one another is determined by the geometrical parameters of a functional group to which the capacitor is to be connected. Such a connector can be associated with an inverter or an power supply, e.g., a battery. The offset of the capacitors is, for example, equal to the offset of the connectors of the external functional group.

One embodiment of the first aspect relates to a capacitor system wherein the connector of one pole of a capacitor and the respective non-homopolar connector of the other capacitor are disposed at different locations on the respective capacitor.

A location in the context of the invention is a place on a capacitor where a connector can be disposed. A location can be at the top of the capacitor. Additionally or alternatively, a location can be at the bottom of the capacitor. In other embodiments, such a location is situated between an upper and a lower delimitation of the capacitor. This can be achieved by a variable schoopage on which a connector of a capacitor can be disposed. In this way two types of capacitors which are disposed next to one another are derived. As a result thereof, the connectors of the capacitors disposed next to one another are at different locations and can thus lead out of the capacitor system without a change in direction and at a substantially consistent spacing.

One embodiment of the first aspect relates to a capacitor system, wherein the connectors in a region in which the connectors run at the same mutual spacing are mutually spaced apart by less than 0.1 mm, 0.2 mm, 0.3 mm, 0.5 mm, 1 mm, 2 mm, 3 mm and/or as defined.

In particular, an offset of the wrapping that can result based on the circumstances just explained determines the spacing of two non-homopolar connectors. Additionally or alternatively, an insulation which is disposed, or to be disposed, between the connectors can determine the spacing between the connectors. Additionally or alternatively, the spacing can be defined by the spacing of the connectors of an external functional group. In order to achieve ideally low inductive interferences, the spacing between two non-homopolar connectors should be as minor as possible.

One embodiment of the first aspect relates to a capacitor system wherein connectors that run next to one another are at least in part mutually separated by an insulation.

The thickness of the insulation may be a parameter which influences the size of the offset, or the substantially consistent spacing between two non-homopolar connectors. The thickness of the insulation is determined according to the requirements in terms of dielectric strength. Furthermore, the insulation can be as thin as possible.

An insulation can comprise an insulating layer. The insulating layer can comprise Kapton, an insulating varnish, a powder coating and/or a dielectric.

One embodiment of the first aspect relates to a capacitor system wherein the capacitor system is specified as an intermediate circuit capacitor; and
a connector of the first capacitor and a respective non-homopolar connector of the second capacitor are specified to couple the capacitor system on the consumer side.

In particular, non-homopolar connectors with a substantially identical spacing can couple the capacitor system to an AC consumer. For example, an AC consumer can be an inverter which is coupled to a motor. Harmonics as AC portions are reflected to the capacitor by the inverter. These harmonics can cause inductive interferences via the connector. Such inductive interferences can at least be minimized by routing the non-homopolar connectors according to the present disclosure.

One embodiment of the first aspect relates to a capacitor system wherein the capacitor is specified as an intermediate circuit capacitor; and wherein a connector of the first capacitor and a respective non-homopolar connector of the second capacitor are specified to couple the capacitor system on the supply side.

In particular, non-homopolar connectors with a substantially identical spacing can couple the capacitor system to an AC supply, for example, a public grid. The same advantages as have already been described in the context of the AC consumer apply here.

One embodiment of the first aspect relates to a capacitor system wherein the capacitor system comprises a housing; and
wherein at least one of the connectors that run at the same mutual spacing leads out between a capacitor and a housing of the capacitor system.

For example, in a capacitor which has its connector neither at the very top nor at the very bottom (thus in the interior of the wrapping, for example), the connector of the capacitor lying next to this capacitor can lead out of the capacitor system between a housing wall and the capacitor with the internal connector. The connector of the capacitor with the internal connector can be disposed such that this connector runs parallel to the connector that leads between the capacitor and the housing wall. By way of this arrangement, two non-homopolar connectors can lead out of the capacitor system. This arrangement is described in FIG. 3 or in FIG. 4, for example.

Additionally or alternatively it is possible that two connectors, which are in each case situated on a capacitor on the upper side (or the lower side) of the latter, at a substantially consistent spacing between a housing wall and a wrapping of a capacitor. This is illustrated in FIG. 1b, for example.

One embodiment of the first aspect relates to a capacitor system wherein the capacitors in terms of their poles are disposed so as to be mutually rotated.

In particular, capacitors of the capacitor system can be disposed such that two capacitors that lie next to one another on one side have in each case non-homopolar connectors. This can be achieved in that two capacitors of the same type are installed so as to be mutually rotated by 180°. As a result of the rotation, the non-homopolar poles are at the same level. When the capacitors are then disposed so as to be offset within the capacitor system, a substantially consistent spacing of the two connectors can be achieved by the offset if these two connectors lead out of their respective capacitor in parallel, for example. In another embodiment, no offset of the capacitors is required. In this case, the connectors can be twisted about one another so as to lead out of the capacitor system at a substantially consistent spacing. As a result of the disposal of the capacitors with reversed poles, advantages in terms of the electromagnetic radiation of the capacitor system are additionally derived because the electromagnetic effects of the individual capacitors partially compensate one another during operation. This also applies to the electromechanical effects. As a result of the disposal of the capacitors with reversed poles, the capacitor system may have lesser acoustic interferences during operation.

One embodiment of the first aspect relates to a capacitor system wherein the capacitor system comprises a housing; and
wherein two poles of identical denomination of two capacitors are coupled by way of the housing.

A housing can also comprise a busbar or be referred to as such. If the capacitors of the capacitor system are wired in parallel, the positive poles of all capacitors of the capacitor system have to be connected to one another. In the case of capacitors which are disposed directly next to the housing, this can take place by way of the housing. This applies to the positive poles as well as to the negative poles of the capacitors of the capacitor system.

A second aspect relates to a production method comprising the following method steps:
disposing at least two capacitors with reversed polarity next to one another;
leading out two non-homopolar connectors, wherein one connector contacts in each case one of the capacitors on one side of the capacitor system and at a substantially consistent spacing, in parallel.

One embodiment of the second aspect relates to a production method comprising steps for producing one of the capacitor systems described above.

Further advantages and features are derived from the following embodiments which relate to the figures. The figures do not show the embodiments true to scale. The dimensions of the various features may be correspondingly enlarged or reduced in size, in particular for reasons of clarity of the description. In the figures, in some instances in a schematic manner:

### BRIEF DESCRIPTION OF THE DRAWINGS

FIG. 1a shows a capacitor system of an embodiment of the present disclosure;

FIG. 1b shows the capacitor system according to FIG. 1a in a front-end view;

FIG. 2 shows a capacitor system according to an embodiment of the present disclosure;

FIG. 3 shows a capacitor system according to an embodiment of the present disclosure; and

FIG. 4 shows a capacitor system according to an embodiment of the present disclosure.

### DETAILED DESCRIPTION OF THE DRAWINGS

In the description hereunder, reference is made to the appended drawings which form part of the disclosure and in which specific aspects in which the present disclosure can be understood are shown for visualization. In the description hereunder, identical reference signs refer to identical features, or features which are at least equivalent in functional or structural terms.

In general, a disclosure pertaining to a method described also applies to a corresponding device for carrying out or producing the method, or to a corresponding system which comprises one or a plurality of devices, and vice versa. For example, when a specific method step is described a corresponding device can comprise a feature for carrying out the method step described, even if this feature is not explicitly described or illustrated. On the other hand, when a specific device is described based on functional units and/or structural features, for example, a corresponding method can comprise a step which carries out the functionality described or by which a corresponding structure can be produced, even if such steps are not explicitly described or illustrated. Likewise, a system can be provided with corresponding device features or with features for carrying out a specific method step. Methods of the various aspects and embodiments described above and hereunder can be combined with one another unless explicitly stated otherwise.

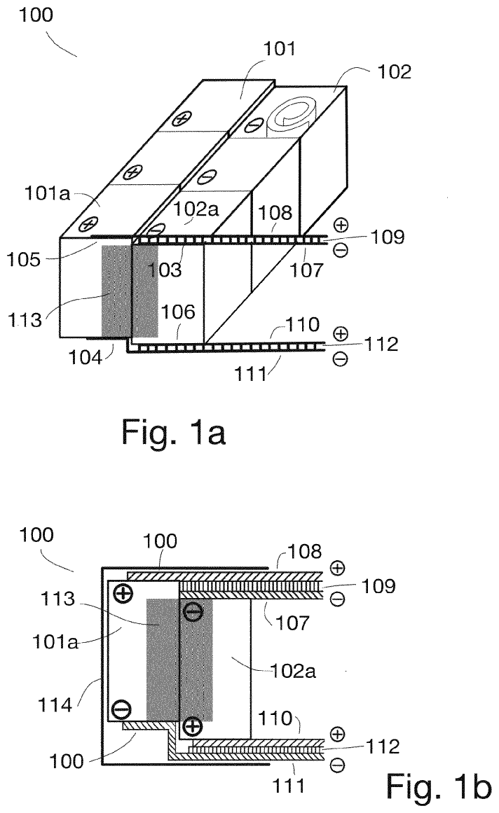

FIG. 1a shows a capacitor system of an embodiment of the present disclosure. The capacitor system 100 comprises six capacitors which are disposed in two rows of three next to one another. In a first row, the capacitors 101 are disposed in a first arrangement. In the second row, the capacitors 102 are disposed next to one another in a second arrangement. The capacitors 101, 102 are configured as film capacitors. To this end, the disposal of the film as a spiralized roll is schematically depicted in one of the capacitors. The capacitors 101 of the first row of three have upper positive connectors 105 as well as lower negative connectors 104. Of course, the capacitors may have further connectors. The capacitors 102 of the other row of three have upper negative connectors and lower positive connectors. The capacitors are wired to one another in parallel so that all six capacitors have a common positive-pole node and a common negative-pole node. To this end, the capacitors are coupled to one another at a plurality of locations. Such a connection 113 is illustrated on the end side of the capacitor system 100. The connection 113 couples the lower negative connector 104 of the capacitor 101a of the capacitor row 101 to the upper negative connector 103 of the capacitor 102a on the end side of the capacitor row 102.

The capacitor system is configured as an intermediate circuit capacitor system. It comprises an output-side connector pair 107, 108. The capacitor system further comprises an input-side connector pair 110, 111. The positive connector 108 of the output-side connector pair is connected to the capacitor 100a on the upper side of the latter. This is illustrated by the reference sign 105. The negative connector 107 of the output-side connector pair is connected to the negative pole of the capacitor 102a. This is illustrated by the reference sign 103. An insulating material 109 is situated between the connector pair 107, 108. The positive connector 110 of the input-side connector pair is connected to the positive pole 106 of the capacitor 102a. The negative connector 111 of the input-side connector pair is connected to the negative pole 104 of the capacitor 101a. An insulating material 112 is likewise disposed between the positive connector 110 and the negative connector 111. As can be seen in FIG. 1a, the capacitor row 101 is disposed so as to be offset from the capacitor row 102. The row with the capacitors 101 in relation to the row with the capacitors 102 is displaced upward by a minor offset. The offset is 1 mm. As a result of this offset and the disposal of the capacitors of the row 101 with reversed poles, the positive upper connector of the capacitor 101a can be disposed in a rectilinear manner and substantially parallel to the upper negative connector of the capacitor 102a, if the negative upper connector of the capacitor 102a likewise leads away from the upper pole 103 of the capacitor 102a in a rectilinear manner. As a result thereof, an output connector pair 108, 107 which leads out of the capacitor system at a substantially consistent spacing of 1 mm can be provided. As a result of the substantially consistent spacing and the parallel disposal of the two connectors, material can be saved on the one hand, and induction effects can be reduced as a result of the rectilinear routing, on the other hand. The input-side connector pair 110, 111 is of a similar embodiment. The negative connector of the input-side connector pair is connected to the negative pole 104 of the capacitor system 101a. The positive connector 110 of the input-side connector pair is connected to the capacitor system 102a at the positive pole 106 of the latter. As a result of the offset, the negative connector 111 upon connecting to the negative pole of the capacitor 101a initially has to overcome the offset of the capacitor row 101 per capacitor row 102, for example, by way of two orthogonal kinks, as in the present embodiment. However, as soon as the connector 111 is led along below the capacitor 102a, this connector can be of a rectilinear shape and lead out of the capacitor system 100 in a rectilinear manner. This makes it possible for the input-side connector pair 110, 111 to likewise lead out of the capacitor system 100 in parallel. To this end, the positive connector 110 likewise has to lead away from the pole 106 of the capacitor 102a in a rectilinear manner. In this way, a requirement in terms of material, as well as induction interferences, as a result of additional kinks and changes in direction, can also be avoided for the input-side connector pair.

The end side of the capacitor system 100 from FIG. 1a is illustrated in FIG. 1b. Additionally illustrated is a housing 114 in which the two capacitor rows are situated. It can be seen how the capacitor 101a at the top has a positive connector and at the bottom has a negative connector, and the capacitor 102a at the top has a negative connector and at the bottom has a positive connector. It is furthermore illustrated in detail how the connectors lead to the outside between the capacitors, which are disposed in an offset manner, and the housing. As a result of the disposal with reversed poles and the offset of the two capacitors it is made possible that the connectors lead out of the capacitor system 100 in an optimal manner, in terms of inductive interferences and the requirement in terms of material. It becomes obvious here that the offset does not inevitably have to take place between the two capacitor rows 101 and 102, but only between the capacitors 101a and 102a, for example. This is because, as a result of the parallel wiring of the capacitors, a positive pole of the capacitors is connected to all other positive poles, and a negative pole is connected to all other negative poles of the capacitor system. Alternatively, another capacitor pair can of course be used for providing the input and/or output connector pairs. In particular, the input connector pair can also be disposed at a consistent spacing on a capacitor pair other than the output connector pair.

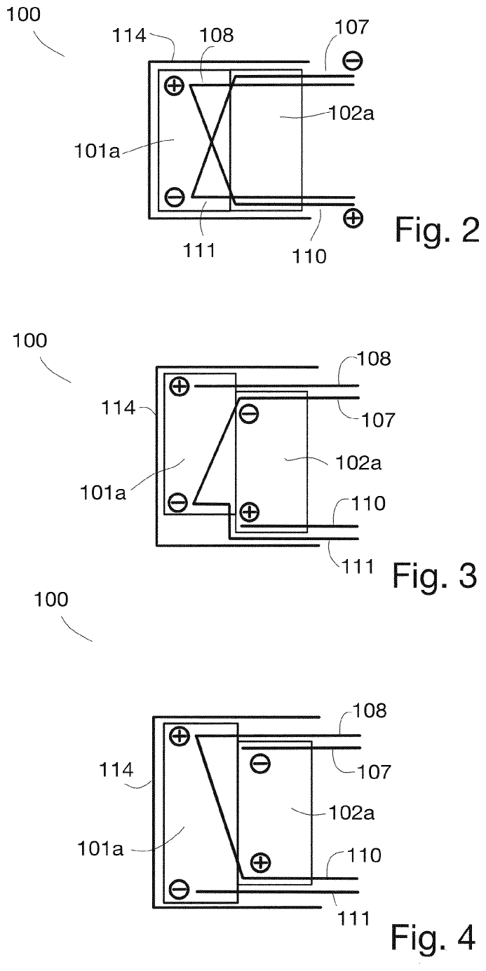

FIG. 2 illustrates an embodiment of a capacitor system 100 according to the present disclosure. The view is a front-end view of two capacitors of a capacitor system 100, similar to the front-end view according to FIG. 1b. Here, two capacitors 101, 102 are disposed next to one another in a housing 114. The capacitor 101 has two connectors. The positive connector is disposed in an upper portion 108 of the capacitor 101a. The negative pole 111 is disposed in a lower portion of the capacitor 101. In contrast, the capacitor 102a in an upper portion has a negative pole, and in a lower portion has a positive pole. The capacitors are not of identical construction. The positive pole 108 of the capacitor 101 is disposed so as to be slightly offset from the negative pole of the capacitor 102. Additionally, the negative pole of the capacitor 101 is disposed so as to be slightly offset from the positive pole of the capacitor 102. As a result of the offset poles, both output connector pairs 107, 108 and 110, 111 can be formed, whereby the connectors of the poles of the capacitors for this can in each case lead out of the capacitor system 100 in a rectilinear manner and in parallel. As a result of the offset connectors in the present installation mode, the connectors can be defined in parallel. This embodiment also achieves the advantages mentioned above.

FIG. 3 shows an embodiment of a capacitor system according to the present disclosure. A front-end view is likewise illustrated. The capacitors here are also disposed with reversed poles and next to one another. Moreover, the capacitors are offset next to one another so that capacitors of the same type can be used in order for the connectors of one connector pair, for example, of the connector pair 107, 108 or of the connector pair 100, 111 to be able to lead out of the capacitor system 100 in a rectilinear manner and in parallel. In this embodiment, the connectors are not disposed on the sides of the capacitors as in FIGS. 1a, 1b. Rather, the connectors are connected to the respective poles within the capacitors 101a, 102a. This can be achieved, for example, by a correspondingly high schoopage at which the connectors are disposed. As a result of the present construction mode and the offset arrangement, the connectors of the two connector pairs 108, 107 as well as 110, 111 can lead out of the capacitor system 100 in parallel. Additionally, the connectors of the capacitor 101a lead out of the housing between the housing and the capacitor 102a.

FIG. 4 shows a further embodiment of the capacitor system according to the present disclosure. A front-end view similar to that of FIG. 1b is again illustrated here. In this embodiment, two capacitors of different construction modes are illustrated next to one another. The capacitor 101a has a lower height than the capacitor 102a. The capacitors 101a, 102a are disposed with mutually reversed poles, thus so as to be mutually rotated. As a result of the present arrangement, all connectors are within the capacitors and are simultaneously able to be led out of the capacitor system 100 in parallel. Here, only the connectors 108, 111 of the capacitor 101a are led between the housing 114 and the capacitor 102a. These embodiments also have the advantages mentioned above.

### LIST OF REFERENCE SIGNS

100 Capacitor system
101 First capacitor row
102 Second capacitor row
101a Capacitor (of the first capacitor row)
102a Capacitor (of the second capacitor row)
103 Negative pole
104 Negative pole
105 Positive pole
106 Positive pole
107 Negative connector
108 Positive connector
109 Insulation, in particular with an insulating material
110 Positive connector
111 Negative connector
112 Insulation
113 Connection of two negative connectors
114 Housing

1-15. (canceled)

16. A capacitor system for an electric power supply, the capacitor system comprising:
a first capacitor row having first capacitors with a connector for a first pole and a connector for a second pole;
a second capacitor row having second capacitors with a connector for a first pole and a connector for a second pole,
wherein the first poles are identically denominated poles, and the second poles are identically denominated poles, and the first poles and the second poles are non-homopolar;
wherein the first capacitor row is disposed so as to be offset from the second capacitor row; and
wherein two non-homopolar connectors of two capacitors are connected to the capacitors on one side of the capacitor system and lead out of the capacitor system at a substantially consistent mutual spacing, in parallel and/or twisted.

17. The capacitor system according to claim 16, wherein the two non-homopolar connectors are led at a substantially consistent spacing at least over one portion of a capacitor or completely over one capacitor.

18. The capacitor system according to claim 16, wherein the two non-homopolar connectors have a smooth profile in a region in which the two non-homopolar connectors are led at the same spacing.

19. The capacitor system according to claim 16, wherein the first capacitors and the second capacitors are disposed so as to be laterally offset from one another.

20. The capacitor system according claim 19, wherein the consistent spacing of the two non-homopolar connectors is defined by the offset of the first capacitors and the second capacitors, according to one of the following parameters:
a thickness of the two non-homopolar connectors and/or a thickness of an insulating layer;
an external electrical functional group to be connected.

21. The capacitor system according to claim 16, wherein a connector of one pole of a capacitor and a respective non-homopolar connector of another capacitor are disposed at different locations on a respective capacitor.

22. The capacitor system according to claim 16, wherein the two non-homopolar connectors in a region in which the two non-homopolar connectors run at a same mutual spacing are mutually spaced apart by less than 0.1 mm, 0.2 mm, 0.3 mm, 0.5 mm, 1 mm, 2 mm, 3 mm and/or as defined.

23. The capacitor system according to claim 16, wherein the two non-homopolar connectors that run next to one another are at least in part mutually separated by an insulation.

24. The capacitor system according to claim 16, wherein the capacitor system is specified as an intermediate circuit capacitor; and a connector of the first capacitor and a respective non-homopolar connector of the second capacitor are specified to couple the capacitor system on a consumer side.

25. The capacitor system according to claim 16, wherein the capacitor system is specified as an intermediate circuit capacitor; and
wherein a connector of the first capacitor and a respective non-homopolar connector of the second capacitor are specified to couple the capacitor system on a supply side.

26. The capacitor system according to claim 16, wherein the capacitor system comprises a housing; and
wherein at least one of the two non-homopolar connectors that run at a same mutual spacing leads out between a capacitor and a housing of the capacitor system.

27. The capacitor system according to claim 16, wherein the capacitors, in terms of their poles, are disposed so as to be mutually rotated.

28. The capacitor system according to claim 16, wherein the capacitor system comprises a housing; and
wherein two poles of identical denomination of two capacitors are coupled by way of the housing.

29. A method for producing a capacitor system, the method comprising:
disposing at least two capacitor rows having capacitors with reversed polarity and offset next to one another;
leading out two non-homopolar connectors, wherein one connector contacts in each case one of the capacitors on one side of the capacitor system and at a substantially consistent spacing, in parallel.

30. The method according to claim 29, wherein
a first capacitor row has first capacitors with a connector for a first pole and a connector for a second pole;
a second capacitor row has second capacitors with a connector for a first pole and a connector for a second pole,
wherein the first poles are identically denominated poles, and the second poles are identically denominated poles, and the first poles and the second poles are non-homopolar.
